(19) United States
(12) Patent Application Publication
(10) Pub. No.: US 2009/0169179 A1
(43) Pub. Date: Jul. 2, 2009

(54) User Adjustable Buffer for Content Recording

(76) Inventor: Carolynn Rae Johnson, Allison Park, PA (US)

Correspondence Address: Thomson Licensing LLC, P.O. Box 5312, Two Independence Way, PRINCETON, NJ, 08543-5312, US

(21) Appl. No.: 11/988,774

(22) PCT Filed: Nov. 8, 2005
(86) PCT No.: PCT/US2005/040695

§ 371 Date: Jan. 14, 2008

(51) Int. Cl. H04N 7/26

(52) U.S. Cl. 386/124; 386/E05.001

(57) ABSTRACT

The present invention provides a method and apparatus in a recording device (100) for enabling the adjustment of the size of a buffer used for temporarily recording program content to a recording medium (148) and/or alternatively for enabling the adjustment of the size of storage used for recording program content for later playback. In one embodiment of the present invention, in determining the length of the temporary recording buffer via a provided user interface (200,400), a user indirectly affects the space available for the recording of program content for later playback and vice versa.

### CROSS-REFERENCE TO RELATED APPLICATIONS

This application claims priority to U.S. Provisional Patent Application Ser. No. 60/703,090 filed Jul. 28, 2005, which is herein incorporated by reference in its entirety.

### FIELD OF THE INVENTION

The present invention generally relates to content recording devices and, more particularly, to a method and apparatus for a user adjustable memory and memory allocation for content recording devices.

### BACKGROUND OF THE INVENTION

Content recording devices, for example, personal video recording systems (PVRs) and digital video recording systems (DVRs), typically buffer programming by recording the program content temporarily to a memory or recording medium such as hard drive, recordable disk, etc. As such, a user is able to pause, rewind and subsequently fast forward programming considered by the user as “live TV”. However, a user may find that a pre-set buffer (e.g., memory) length for the recording device may not be long enough to facilitate a user to rewind to a desired point in the programming beyond what is enabled by the buffer size and available in the buffer. In contrast, a user may also experience a situation where the buffer capacity of the content recording device is not being fully utilized and would instead prefer to use the unused storage capacity of the buffer to permit additional recording of program content for later playback.

For example, TiVo™ provides a standard 30-minute buffer, which is not adjustable by a user. Similarly, the buffer provided by ReplayTV™ is based solely on the amount of storage space available to the system. In either of the systems above, a user is unable to specify a buffer length, thus at any given time, the length of the buffer may be too long or too short for the user or application. In such conventional systems, the only way that a user is able to change the length of the buffer, if provided at all, is to delete programming stored to the device.

### SUMMARY OF THE INVENTION

The present invention advantageously provides a method and apparatus in a content recording device for enabling a user to adjust the size of a buffer for temporarily recording program content and/or alternatively for enabling the adjustment of the size of a storage device used for recording program content for later playback. In one embodiment of the present invention, a method for memory allocation in a content recording device includes allocating a first portion of a storage device, used by the content recording device to store media content, for the temporary recording of media content, where the size of the first portion is user determinable. In addition, the method can further include allocating a second portion of the storage device for the recording of media content for later playback. In determining the length of the temporary recording buffer via a provided user interface, a user indirectly affects the space available for the recording of program content for later playback and vice versa.

In an alternate embodiment of the present invention, a content recording device includes at least a storage device for storing media content, a user interface for enabling a user to define at least what portion of the storage device is to be used for the temporary recording of media content, and an interface controller for, in response to the user definition, allocating a first portion of the storage device for the temporary recording of media content.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a personal video recorder in accordance with one embodiment of the present invention;

FIG. 2 depicts an example of a user interface menu for enabling a user to select a buffer length in accordance with an embodiment of the present invention;

FIG. 3 depicts a banner used to alert a user of the total time available and the time remaining in a buffer of a content recorder for live TV in accordance with an embodiment of the present invention; and

FIG. 4 depicts an example of a user interface menu for enabling a user to select a buffer length in accordance with an alternate embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and apparatus for enabling a user to adjust a buffer length for a content recording device. Although the present invention will be described primarily within the context of a personal video recorder (PVR), the present invention is not so limited. It will be appreciated by those skilled in the art and informed by the teachings of the present invention that the concepts of the present invention may be applied in substantially any content recording device such as personal recording devices (PVRs), digital video recording systems (DVRs), DVD recorders utilizing rewriteable disks, and the like, wherein it is desirable to adjust an amount of memory available for the temporary storage of program content.

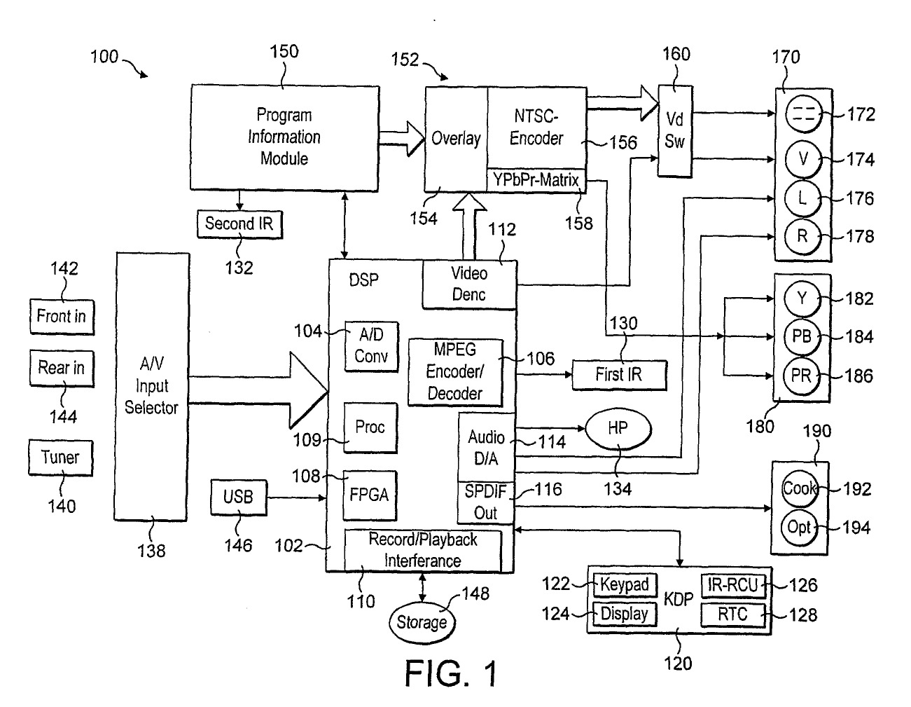

FIG. 1 depicts a high level block diagram of a personal video recorder (PVR) in accordance with one embodiment of the present invention. The personal video recorder 100 of FIG. 1 illustratively comprises a digital signal processor (DSP) 102, a key and display board 120, a tuner 140, an A/V input selector 138, a USB input 146, a recording medium/storage device 148 and a program information module 150. Additionally, the PVR 100 comprises first and second infra-red (IR) links 130 and 132, a video overlay encoder 152, a video switch 160, a headphone jack 134, a standard A/V component connector block 170, a Y Pr Pb component connector block 180, and a digital interface connector block (e.g., a Sony/Phillips digital interface SPDIF) 190.

The component connector blocks 170, 180 and 190 provide audio/video signals in a variety of output formats. For example, the standard A/V component connector block 170 can comprise an S-video connector 172 for outputting to a video display video that has been separated into chrominance and luminance video signals and a composite video connector 174 for providing a standard composite video signal. Further, the standard A/V component connector block 170 can comprise left and right audio output connectors, 176 and 178, respectively.

The Y Pr Pb component connector block 180 is implemented for high definition television (HDTV). The Y Pr Pb component connector block 180 includes a video luminance (Y) output connector 182 for providing an analog video luminance component, a Pb output connector 184 for providing an analog blue color difference (B−Y), and a Pr output connector 186 for providing an analog red color difference (R−Y). Lastly, the SPDIF component connector block 190 comprises a coaxial output 192 and an optical output 194 for outputting digital audio signals via a coaxial cable or fiber optic cable, respectively.

The key and display board 120 are provided as a user interface for the PVR 100 and illustratively incorporate a keypad 122, a display 124, an IR remote control interface 126 and a real time clock 128. By using the keypad 122 or the IR remote control interface 126, a user can select functions to be executed by the PVR 100. For example, a user can choose to change channels on the PVR 100, to perform trick mode playback or to configure the PVR 100. The user interface 120 can also be used to perform the various aspects of the present invention. That is the key and display board 120 as well as other user interface means, such as a remote control, or buttons located on the PVR 100 itself, can be utilized by a user to adjust the size of a buffer for temporarily recording program content and/or alternatively for enabling the adjustment of the size of a buffer used for recording program content for later playback described in greater detail below.

The real time clock 128 maintains time, which can be shown by the display 124. The display 124 also can display other information as well, for example a trick mode being executed on the PVR 100, a selected channel being recorded by the PVR 100, or an identifier for a presentation being shown on a video display.

The PVR 100 of FIG. 1 illustratively comprises first and second IR links 130 and 132 which form a set of communication links between satellite and non-satellite applications to help simplify the interface between the audio, video, and data streams. The first IR link 130 can be a communication interface between the DSP 102 and other devices having an IR communication link. Notably, the first IR link 130 can be useful for controlling other devices designed specifically for aired or cable television broadcasts or radio broadcasts using standard program guide information. The first IR link 130 also can enable features to simplify the consumer's interaction between devices. For example, the first IR link 130 can enable one touch program recording, as well as other user conveniences. The second IR link 132 can provide an interface between the program information module 150 and other devices having IR communication links. Significantly, the second IR link 132 can be useful for communicating with devices not requiring a direct connection to the DSP 102, for example with a cable reception device, a VCR, etc.

The digital signal processor 102 illustratively comprises an analog to digital (A/D) converter 104, an MPEG encoder/decoder 106, a field programmable gate array (FPGA) 108, a micro controller 109, a recorder/playback interface 110, a digital video processor/encoder 112, an audio digital to analog converter (audio D/A) 114 and a SPDIF output 116. The DSP 102 can further include one or more data busses enabling the different DSP components to communicate with each other and cooperatively process data. Notably, interrupt requests (IRQs) and direct memory addresses (DMAs) can be utilized to facilitate buss communications and data processing.

Audio/Video (A/V) input selector 138 can include a plurality of A/V (i.e., media content) inputs. For example, the input selector 138 can incorporate an A/V input to receive A/V (e.g., media content) signals from the tuner 140. The input selector 138 can also receive signals from various other input devices as well. For example, a video camera can send A/V signals to the input selector 138 via front A/V input 142, and a VCR can send A/V signals via rear A/V input 144. Significantly, other A/V devices can be connected to the A/V input selector 138 as well. The A/V input selector 138 forwards the received A/V signals to the DSP 102. The DSP's A/D converter 104 is used to convert A/V signals received in an analog format to a digital format. A/V signals already in digital format can bypass the analog to digital conversion, for example, digital signals received via a universal serial buss (USB) interface 146.

The field programmable gate array 108 provides instructions which are acted upon by the controller 109 for processing data received from the A/V input selector 138 or the USB interface 146, depending on the type of data received. For example, if A/V data is received in an uncompressed form, the FPGA 108 and the controller 109 can control the processing of A/V data by the MPEG encoder/decoder 106 for MPEG compression prior to being sent to the record/playback interface 110. However, if A/V data is received in an MPEG compressed format, the FPGA 108 and the controller 109 can controllably couple the A/V data to the receive/playback interface 110. In either case the FPGA 108 can provide read/write instructions which are implemented by the controller 109 and the record/playback interface 110, for storing the A/V data on the recording medium/storage device 148.

The MPEG encoder/decoder 106 performs MPEG compression and decompression on digital A/V signals. For example, the MPEG encoder/decoder 106 can receive digital A/V signals from the A/D converter 104 or the USB interface 146, compress the digital A/V signals using an MPEG format, and forward the compressed digital A/V signals to the receive/playback interface 110. The receive/playback interface 110 then stores the compressed digital A/V signals to the recording medium/storage device 148. In addition the MPEG encoder/decoder 106 can identify input video signals containing 3:2 pull down artifacts indicative of conversion from 24 fps film original sources. Having identified TV image material format converted from film original, the MPEG encoder 106 can identify the duplicate, and therefore redundant picture material, which is then discarded prior to MPEG compression.

The recording medium/storage device 148 can include one or more data storage devices. For example, a data storage device can be a magnetic storage medium, such hard disk drive (HDD), an optical storage medium, such as a digital video disk (DVD), an electronic storage medium, such as random access memory (RAM), a magneto/optical storage medium, or any combination of storage devices.

During playback, the record/playback interface 110 reads media content (e.g., A/V data) from the recording medium/storage device 148. The A/V data is then forwarded to the MPEG encoder/decoder 106 for decompression. After decompression the A/V data can be separated into video and audio signals. The audio signal is forwarded to the SPDIF output 116 to be output digitally via the coaxial output 192 or the optical output 194. The audio signal can also be forwarded to the audio D/A converter 114 for D/A conversion. After D/A conversion, the audio signal can be output via headphone jack 134 and/or the left and right audio outputs 176 and 178.

The decompressed digital video signal is processed by the digital video processor encoder 112, which constructs the required display picture rate, for example nominally 30 fps, performs D/A conversion of the video signal, and encodes the video signal into a variety of formats. For example, the video signal can be transcoded to form an RGB component format, separated into luminance and chrominance (Y+C) signals, or encoded into a composite NTSC video signal. The composite video and the Y+C video signals are forwarded to the video switch 160, while the RGB video signals are forwarded to the video overlay encoder 152. The video overlay encoder 152 illustratively comprises the overlay module 154, NTSC video encoder 156, and the Y Pr Pb matrix encoder 158. The overlay module 154 receives program information from a program information module 150 and graphically overlays the program information onto the video signal. The program information module 150 extracts the program information from an on-line program guide or a program guide contained in incoming A/V signals received by the A/V input selector 138 and communicated to the program information module 150 by the DSP 102. The program information can include available programs for each channel as well as program scheduling.

Further, for each individual program the program information can include a program identifier, channel information, recording time, program duration, scene data, program credits, etc. Other information and graphics may be overlaid, superimposed or inserted into the video signal as well. For example, a clock, text blocks, user information, menus, icons, pictures, etc. can be overlaid or combined with the video signal. Typically, information is overlaid onto the video signal when requested by a user or upon some pre-defined event. However, some information, such as a channel identifier, can be continually overlaid over the video signal.

The NTSC video encoder 156 can output the video signal as an NTSC formatted composite video signal, as well as video separated into separate luminance and chrominance signals. The video signals can then be forwarded to the video switch 160. The video switch 160 is used to select for display either the NTSC encoded video signal or the video signal generated by the video digital encoder 112. Composite video signals from either source are output via the composite video output connector 174, while chrominance and luminance video signals from either source can be output via the S-video output connector 172.

The Y Pr Pb matrix encoder 158 generates a Y Pr Pb formatted analog video signal. As previously noted, the Y Pr Pb component video signals include an analog video luminance (Y) signal, an analog red color difference (R−Y) and an analog blue color difference signal (B−Y). The luminance or Y component can be output to the Y output connector 182, the (B−Y) difference can be output to the Pb output connector 184 and the (R−Y) difference can be output to the Pr output connector 186.

As previously stated and described above, content recording devices such as the PVR 100 of FIG. 1 typically buffer programming (i.e., received media content) by recording the media content temporarily to a storage device (e.g., memory, recording medium such as a hard drive, etc), such as the storage device 148 of the PVR 100 of FIG. 1. As such, a user is able to pause, rewind and subsequently fast forward programming considered by the user as “live TV”. In addition, content recording devices also typically record media content temporarily on the same storage device (e.g., memory, recording medium such as a hard drive, etc), such as the storage device 148 of the PVR 100 of FIG. 1. Although in the PVR 100 of FIG. 1 a storage device 148 illustratively is used for storing both temporary media content and media content temporarily, in alternate embodiments of the present invention, a PVR in accordance with the present invention can comprise a separate buffer for storing temporarily recorded media content and the separate buffer can be used in conjunction with the separate storage device to perform the concepts of the present invention as described below.

In accordance with the present invention, a user is given the ability to select to use a standard buffer length or to specify a buffer length that will be used in place of the standard length for temporarily recording program content to the storage device. Read/write operations for storing the media content (e.g., received A/V data) on the storage device 148 are implemented by the controller 109 and the record/playback interface 110. More specifically and in accordance with one embodiment of the present invention, the storage of media content in the storage device 148, either for temporary storage or storage for later playback, is performed by the controller 109 and the record/playback interface 110. However, the relative amount of space made available in the storage device for the recording of media content to be temporarily stored versus the amount of space made available in the storage device for the recording of media content for later playback is determined in response to a user input via a user interface.

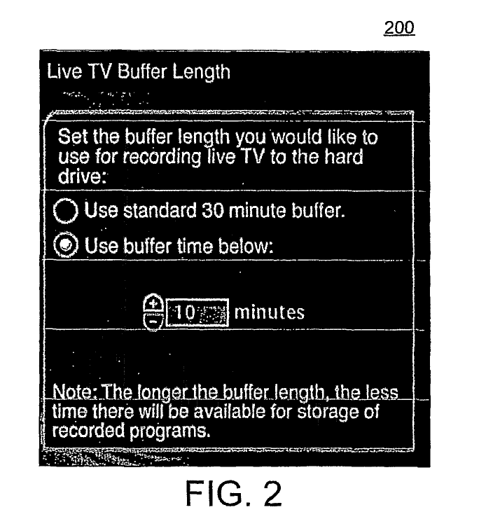

For example, FIG. 2 depicts an example of a user interface menu for enabling a user to select how much of an available storage device, such as the storage device 148 of the PVR 100 of FIG. 1, to allocate for the temporary recording of received media content in accordance with an embodiment of the present invention. The portion of the storage device allocated for the temporary recording of received media content is considered herein by the inventors as the buffer length of a recording device. The interface menu 200 of FIG. 2 illustratively comprises a selection area for allowing a user to select whether to use a predetermined, standard buffer length for a recording device (e.g., PVR) or to select the use of a non-standard buffer length and to specify the desired length of time for the buffer. That is, if a user decides to use the standard buffer length, no more input would be required from the user. However, if the user decides to set a different buffer length, the user, in one embodiment of the present invention, would be required to enter a time to use as the new buffer length. After a buffer length is selected by a user, the record/playback interface 110 apportions the memory available on the recording medium (e.g., the storage device 148) appropriately for making the selected buffer length available. That is, in one embodiment of the present invention, the record/playback interface 110 divides the storage device (e.g., the storage device 148) into a first portion available for the temporary recording of received media content (buffer length), the amount of memory in the first portion being determined by the buffer length selected by a user, and a second portion available for recording of media content for later playback (permanent memory), the amount of memory of the first portion being determined by the amount of remaining storage space of the storage device.

In an alternate embodiment of the present invention, a user interface may alternately enable a user to select how much of an available storage device, such as the storage device 148 of the PVR 100 of FIG. 1, to allocate for the recording of received media content for later playback. In such an embodiment of the present invention, an amount of storage space of the storage device available for the temporary recording of received media content is determined by the amount of remaining storage space of the storage device.

In yet an alternate embodiment of the present invention, a user interface may enable a user to select how much of an available storage device to allocate for both, the recording of received media content for later playback and how much of a storage device to allocate for the temporary recording of received media content.

Referring back to FIG. 2, optionally, the interface menu 200 can further comprise text to alert a user that longer buffer lengths reduce the storage space available for recording programming events as depicted in the interface menu 200 of FIG. 2. In the example of FIG. 2, a user has chosen to use a time other than the standard buffer length by highlight and selecting “Use buffer time below:” and has entered a time of ten minutes for the buffer time.

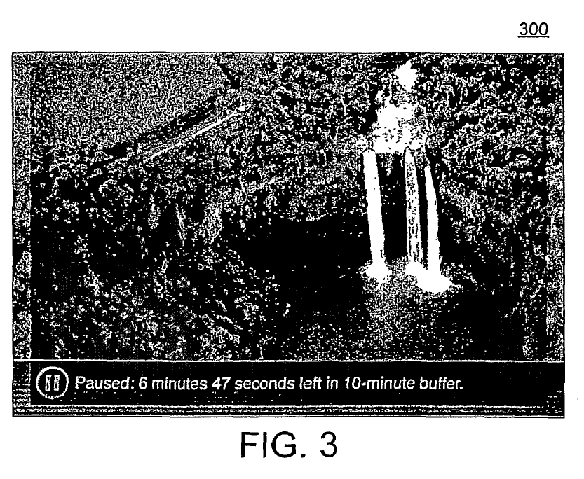

Further and in accordance with the present invention, a user may optionally be alerted of a total time available or remaining in the buffer for temporarily recording content. For example, FIG. 3 depicts a banner 300 used to alert a user of a total time available in a buffer for live TV, as well as the time remaining in the buffer in accordance with an embodiment of the present invention. More specifically, in the screen shot of FIG. 3, the banner 300 appears at the bottom of the screen alerting a user of a total time available in the buffer and the time remaining in the buffer. The illustrative screen shot depicted in FIG. 3 is displayed during a pause function, and similar screens can be displayed during trick modes, such as during rewinding and fast forwarding.

By enabling the selection of a buffer length for temporarily recording content in accordance with the present invention, a user is able to increase or decrease the amount of storage available for recording of program content for later playback. More specifically, if a buffer length for temporarily recording content is reduced by the methods of the present invention described above, an amount of storage space available for the recording of program content for later playback is increased. However, the reduction in the buffer length reduces the amount of content able to be temporarily stored on the storage medium during, for example, a pause event and thus reduces an amount of time that recorded content can be rewound. Conversely, if a buffer length for temporarily recording content is increased, an amount of storage space available for the recording of program content for later playback is decreased. However, the increase in the buffer length for temporarily storing content increases an amount of content able to be temporarily stored on the storage medium during, for example, a pause event and thus increases an amount of time that recorded content can be rewound.

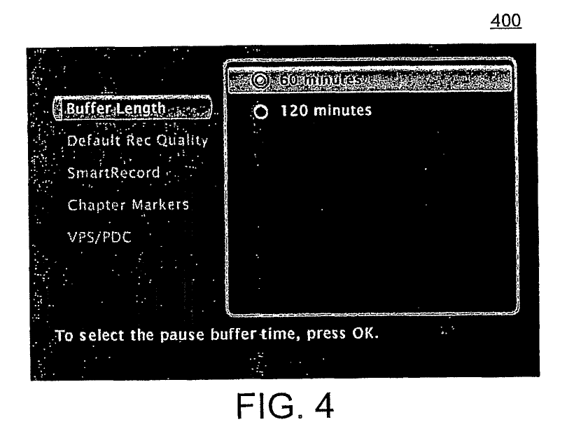

In an alternate embodiment of the present invention, a user interface menu comprises a list of predetermined buffer lengths for enabling a user to select a buffer length. For example, FIG. 4 depicts an example of a user interface menu for enabling a user to select a buffer length in accordance with an alternate embodiment of the present invention. The interface menu 400 of FIG. 4 illustratively comprises a selection area for allowing a user to select from among a number of predetermined lengths for the buffer of a recording device (e.g., PVR). More specifically, in the embodiment of the present invention of FIG. 4, a user is able to select between a buffer length of 60 minutes or 120 minutes. Illustratively, in the example of FIG. 4, a user has selected a buffer length of 60 minutes.

Having described preferred embodiments for a method and apparatus for user adjustable memory and memory allocation for content recording devices (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof. As such, the appropriate scope of the invention is to be determined according to the claims, which follow.

1. A method for memory allocation in a content recording device, comprising:
allocating a first portion of a storage device, used by said content recording device to store media content, for temporarily recording media content, wherein said first portion is user determinable.

2. The method of claim 1, further comprising:
allocating a second portion of said storage device for recording media content for later playback.

3. The method of claim 2, wherein the first portion and the second portion of said storage device comprise a total storage space available for recording media content.

4. The method of claim 2, wherein a size of the first portion and a size of the second portion of said storage device are predetermined and a user can accept or modify the predetermined sizes.

5. The method of claim 1, wherein a size of the first portion and a size of the second portion of said storage device are allocated in response to a user input.

6. The method of claim 1, wherein if a size of the first portion of said storage device, implemented for temporarily recording of media content, is reduced, a size of a second portion of said storage device, implemented for recording media content for later playback, is increased.

7. The method of claim 1, wherein if a size of the first portion of said storage device, implemented for temporarily recording media content, is increased, a size of a second portion of said storage device, implemented for recording media content for later playback, is reduced.

8. The method of claim 7, further comprising generating an alert that increasing storage for temporarily recording media content reduces storage available for recording media content for later playback.

9. The method of claim 1, wherein a size of the first portion of said storage device is predetermined and a user is enabled to accept or to modify the predetermined size.

10. The method of claim 1, wherein a size of the first portion of said storage device is allocated in response to a user input.

11. The method of claim 1, further comprising generating an indication of an amount of storage space remaining out of a total amount of storage space allocated for the temporary recording of media content.

12. The method of claim 1, wherein an amount of storage space allocated for the first portion of said storage device is selected from among a number of predetermined sizes for the first portion.

13. The method of claim 1, wherein a portion of a second storage device is allocated in addition to the first portion of said storage device for fulfilling a user determined size requirement for the temporary recording of media content, said second storage device being implemented for recording of media content for later playback.

14. A content recording device, comprising:
a storage device for storing media content;
a user interface for enabling a user to define at least what portion of said storage device is to be used for the temporary recording of media content; and
an interface controller for allocating a first portion of said storage device for the temporary recording of media content, in response to said user definition.

15. The content recording device of claim 14, wherein said storage device comprises a buffer.

16. The content recording device of claim 14, wherein said interface controller, in response to said user definition, further allocates a second portion of said storage device for the recording of media content for later playback

17. The content recording device of claim 14, wherein said user interface comprises a user interface menu.

18. The content recording device of claim 17, wherein said menu comprises an alert that increasing a size of a storage space for the temporary recording of media content reduces a storage space available for the recording of media content for later playback.

19. The content recording device of claim 14, wherein a size for the first portion of said storage device is selected from among a number of predetermined sizes.

20. The content recording device of claim 14, further comprising a second storage device for fulfilling a user determined size requirement for the temporary recording of media content, said second storage device being implemented for recording of media content for later playback.

21. A content recording device, comprising:
an interface controller for defining a first memory portion and a second memory portion on a storage device, used by said content recording device to store media content, for determining an amount of memory available for the temporary recording of media content on said recording medium and an amount of memory available for the recording of media content for later playback, wherein at least one of said first memory portion and said second memory portion is user determinable.
